(19) United States
(12) Patent Application Publication
(10) Pub. No.: US 2007/0289185 A1
(43) Pub. Date: Dec. 20, 2007

(54) Quilt display system and method

(76) Inventor: James S. Huston, Rushville, IN (US)

Correspondence Address: DANIEL O'CONNOR, 6720 BUCKHORN DRIVE # 821, INDIANAPOLIS, IN, 46254, US

(21) Appl. No.: 11/446,705

(22) Filed: Jun. 5, 2006

(51) Int. Cl. G09F 7/22

(52) U.S. Cl. 40/617

(57) ABSTRACT

A quilt rack or support which is used in combination with a quilt display or other related fabrics or textiles. The support includes upper, rear and side walls fabricated of wood. Each of the side walls includes an interior slotted area. The slotted areas are curved and sized so as to receive the end portions of elongated support rods. The elongated support rods include flutted portions. In the method of use, a quilt is draped over a top elongated support rod and retained in a display position via cooperation between the top elongated support rod and a lower elongated support rod.

### BACKGROUND AND OBJECTS OF THE INVENTION

The present invention is generally related to the fabric, textile, display and support arts and, in particular, to a system and method for displaying a quilt structure.

Systems currently used or in past use in the art have proven to be so costly and complex that they have not found widespread use. Some prior art systems have proven to be damaging to the quilt or fabric structure which is a serious problem especially for the more expensive articles on display.

Another problem faced in the art has been the need for a display system which accents the displayed quilt and which does not detract from it.

Accordingly, it is an object of the present invention to demonstrate a quilt display system which shows the fabric item without damaging it in any way. That is, no potentially damaging fasteners are used in practice of the novel method.

It is also an object of the invention to set forth a fabric support and display system which can be easily utilized without the need for separate tools or fasteners.

It is a further object of the invention to describe a quilt or fabric display system which may be economically manufactured for widespread commercial appeal in the art.

These and other objects and advantages of the invention will be apparent to those of skill in the display and support arts.

### PRIOR ART PATENTS AND DESIGNS

During the course of preparing this specification for submission to the U.S. Patent Office, a full search of the prior art was conducted.

U.S. Pat. No. 6,219,892 issued to Johnsen in 2001 shows a display hanger for sheet items of fabric art including quilts, blankets and other related units. The system includes spring biased clamping bars to retain a quilt in a desired display position.

U.S. Pat. No. 4,736,535 issued to Rucker in 1988 teaches the use of a vertical embroidery frame for use with quilting, rug making or the like.

The present invention is submitted to clearly define over these and all related prior art designs as shown in the support arts.

### SUMMARY OF THE INVENTION

A quilt, fabric or textile support and display rack is provided which comprises a plurality of wooden panels which are utilized to provide an attractive partial canopy cover for the quilt.

Two of the side wooden panels are slotted to receive the ends of elongated wooden support rods.

The wooden support rods have tongue elements formed on the ends thereof which are sized so as to fit slideably into the slots formed in the wooden side panels.

The method steps utilized in practice of the invention include:

draping the upper portion of a quilt over one of the elongated support rods which is an upper position within the formed slots,

lowering the first elongated support rod and the quilt down via the slots so as to contact a second elongated support rod to thus display a quilt without damaging it.

### BRIEF DESCRIPTION OF THE DRAWING FIGURES

FIG. 1 is a front view of the wall portions of the quilt or fabric support.

FIG. 2 is a side schematic view of the support unit as mounted to a wall.

FIGS. 3 and 4 show the curved slots formed in the left and right hand side walls. The slots slideably hold the ends of elongated quilt support rods.

FIGS. 5 and 6 show the elongated support rods used to hold a quilt in a display position without damaging the fabric.

FIG. 7 is a view along line 7--7 of the FIG. 5 rod and shows the fluted or groove elements 55 which are utilized to form an optimal gripping surface to retain the quilt in a desired display position.

FIG. 8 is another schematic front view of the unit with the elongated support rods in place.

FIG. 9 is a side schematic view for the method step of draping a quilt over the upper support rod 50.

FIG. 10 is a side schematic view of the quilt in display position between rods 50 and 60 and facing toward a display area 100.

### FULL DESCRIPTION OF THE PREFERRED EMBODIMENTS

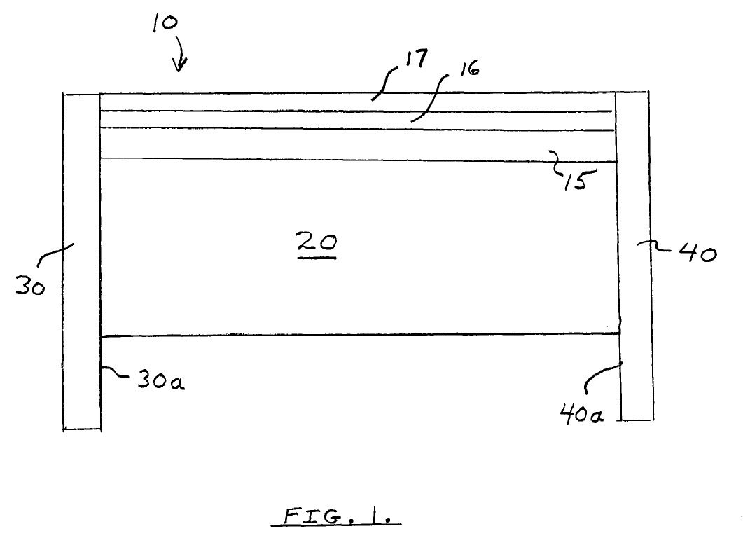

Referring to FIG. 1, a portion of the overall support unit 10 is shown as having a top wall 15 and a rear wall 20.

The top wall 15 has provisions for the mounting of decorative portions indicated schematically at numerals 16 and 17.

The support unit 10 further includes side walls as indicated at numerals 30 and 40.

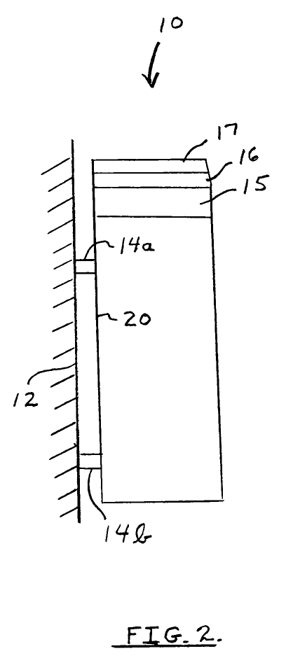

As shown schematically in FIG. 2, the overall support unit 10 can be mounted to a wall surface 12 by means of conventional fastener elements shown at numerals 14a and 14b.

It is contemplated that the components shown in FIGS. 1 and 2 would be comprised of wood although other equivalent materials may be utilized and still be within the intended scope of the invention.

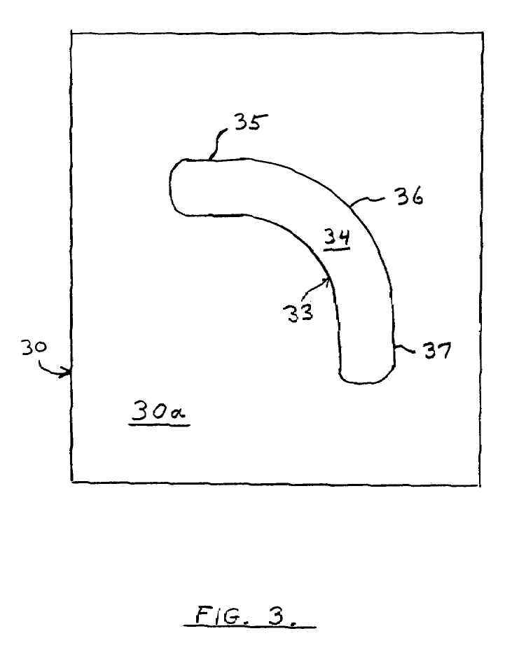

Sidewall 30 has an inner side 30a as shown in FIG. 1 and FIG. 3.

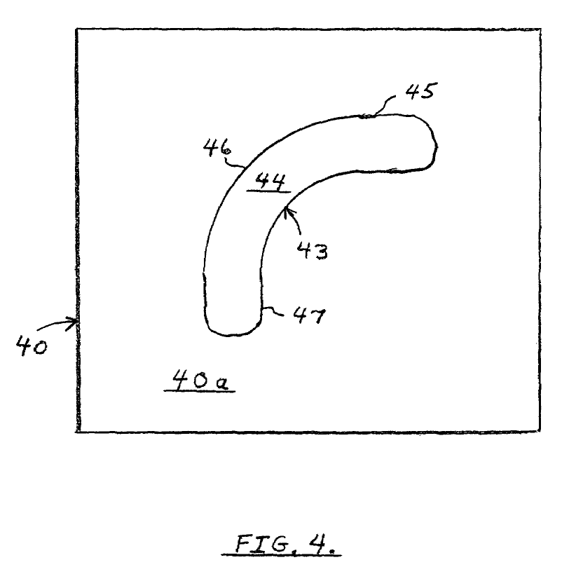

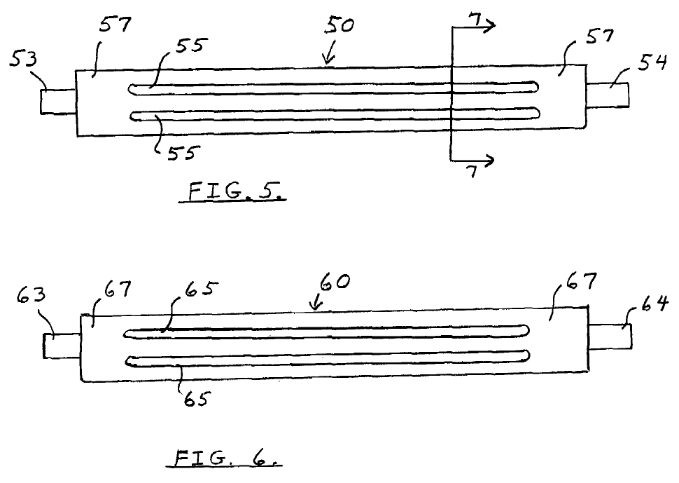

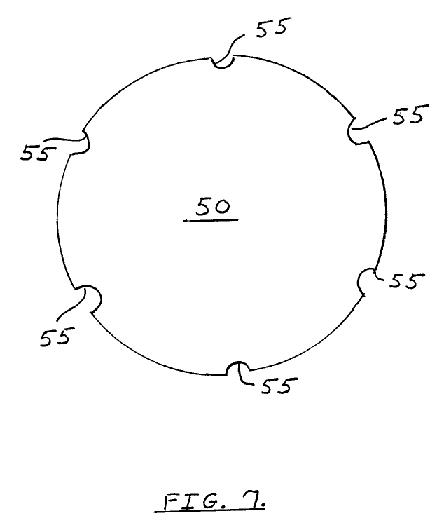

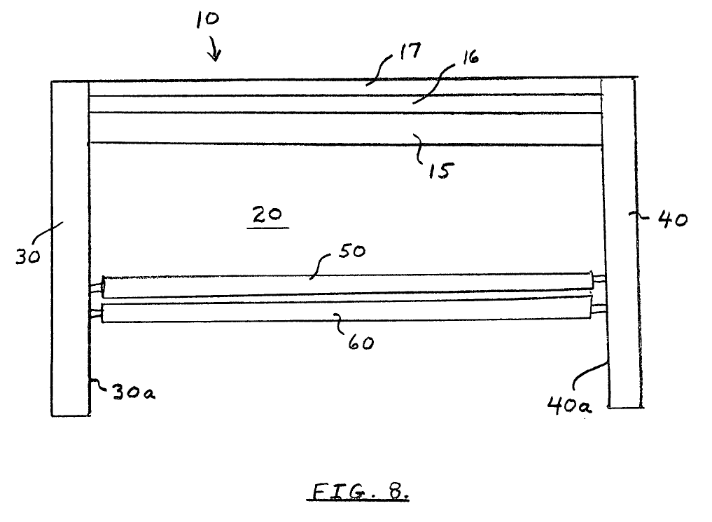

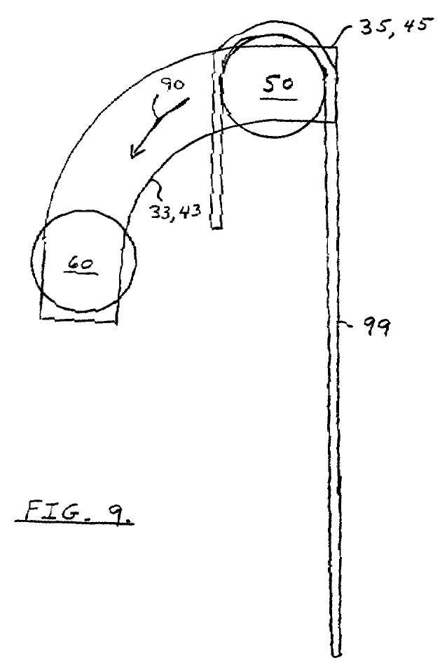

Sidewall 40 has an inner side 40a as indicated in FIG. 1 and FIG. 4.

As shown in FIG. 3, inner side 30a has a curved slot 33 formed therein. Slot 33 has a bottom wall 34. It further has an upper horizontal section 35, a lower vertical section 37 and a middle curved section 36.

As shown in FIG. 4, inner side 40a has a curved slot 43 formed therein. Slot 43 has a bottom wall 44. It further has an upper horizontal section 45, a lower vertical section 47 and a middle curved section 46.

As will be further described, the curved slots 33 and 43 are as mirror images of each other.

Thus, the ends of a pair of elongated support rods, to be further described, can ride in the slots 33 and 43.

As shown in FIGS. 5 and 6, the system further includes two elongated support rods or dowels 50 and 60.

Support rod 50 includes a left hand tongue portion 53 which rides in slot 33. It also has a right hand tongue portion 54 which rides in slot 44.

Support rod 50 further includes fluted areas 55 covering most of the central portion and smooth areas 57 located just outside the fluted areas. The fluted areas are simply elongated grooves as shown.

As shown in FIG. 6, elongated rod 60 has a left hand tongue portion 63 which is sized to ride in slot 33 and a right hand tongue portion 64 which is sized to ride in slot 44.

Elongated rod 60 further has central fluted or grooved areas shown at numerals 65 and smooth areas 67 located just outside the fluted areas.

FIG. 7 is an example of the possible sizing of the fluted or grooved areas.

FIG. 8 is a front schematic view of some of the major system components without the quilt or fabric attached to the support.

As shown, both of the elongated support rods 50 and 60 are in a lowered position, i.e. the rod ends are at a lower portion of the curved slots.

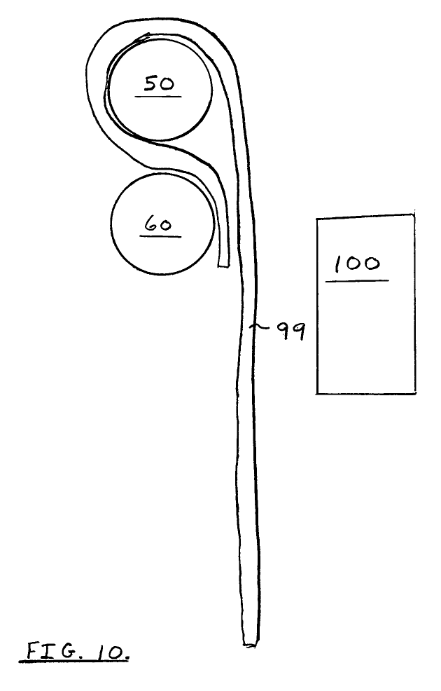

FIGS. 9 and 10 illustrate the method steps in use of the invention.

In FIG. 9, the support rod 50 is moved to an upper position 35, 45 within the curved slot elements 33, 43. Next, the top part of a quilt 99 or fabric is draped over the rod 50. Then, rod 50 and the quilt 99 are lowered so the quilt contacts the lower support rod 60 as indicated by arrow 90.

The quilt is thus retained in a display position without the need for damaging fasteners. See FIG. 10.

As shown in FIG. 10, the quilt 99 covers the elongated support rods 50 and 60 when it is placed in accord with the invention method as viewed from a display viewing area 100.

While a particular system and method of use have been shown and described, it is intended in this specification to cover all equivalent systems and methods which would reasonably occur to those of skill in the art.

U.S. and foreign copyright protection is claimed for the device as a structural work of art,

The invention is further defined by the claims appended hereto.

I claim:

1. A support device in combination with a quilt or other fabric comprising,
a top wall and a rear wall, said top wall having decorative portions mounted thereon, the support device further including a first side wall and a second side wall,
said first side wall having a curved slot formed therein,
said second side wall also having a curved slot formed therein,
said curved slots supporting the ends of a pair of elongated support rods.

2. The support device of claim 1 wherein said elongated support rods have fluted or grooved areas formed in the middle thereof.

3. The support device of claim 2 wherein a portion of said device is mounted to a wall or stand to suitably display a quilt or textile material.

4. The support device of claim 3 being used, in combination, with a method of displaying a quilt, said method comprising the steps of:
(a) draping a quilt or other fabric item over a first upper elongated support rod,
(b) lowering the quilt and the upper elongated support rod onto a second elongated support rod,
(c) retaining said quilt in its desired display position by the slight compression contact between the quilt and the first elongated support rod and also between the quilt and the second elongated support rod.

5. The support device of claim 4 wherein said curved slots each include an upper horizontal portion, a lower vertical portion and a central curved portion.

6. The support device of claim 5 wherein at least central portions of the support rods are hidden from view during the quilt display.

7. A method of operating a quilt or fabric supporting device which includes a pair of side walls having slots formed therein and further includes a pair of elongated supporting rods, said method comprising the steps of:
(a) moving one of said elongated support rods to an upper position within the slots,
(b) draping an upper portion of a quilt or fabric over said elongated support rod,
(c) moving said combined quilt and elongated rod to a lower position within the support device to provide compression on the quilt and thus provide for display of the quilt without damaging it.

8. The method of claim 7 wherein at least one of said elongated supporting rods has plural grooves or flutes formed thereon to provide a gripping force or action when a quilt or fabric is draped thereover.
